(19) United States
(12) Patent Application Publication
(10) Pub. No.: US 2026/0278475 A1
(43) Pub. Date: Sep. 17, 2026

(54) MACHINE LEARNING-BASED AUTOMATIC EVALUATION THRESHOLD CALIBRATION

(71) Applicant: Oracle International Corporation, Redwood Shores, CA (US)

(72) Inventor: Liyu Gong, Lexington, KY (US)

(21) Appl. No.: 19/077,178

(22) Filed: Mar. 12, 2025

(51) Int. Cl. G06N 20/10

(52) U.S. Cl. CPC G06N 20/10

(57) ABSTRACT

A method and apparatus provide machine learning automatic evaluation threshold calibration. Human-generated labels are accessed. Each human-generated label represents a decision of acceptability of a respective output of a plurality of outputs of a first ML model. A plurality of automatic evaluation metric scores are accessed. Each automatic evaluation metric score represents a determination by a second ML model of a quality of a respective output of the plurality of outputs. An automatic evaluation metric score threshold is determined using a third ML model based on the human-generated labels and the plurality of automatic evaluation metric scores.

### FIELD

The present disclosure relates to automatic evaluation of large language models (LLM) and, more specifically, to machine learning-based automatic evaluation threshold calibration.

### BACKGROUND

Large Language Models (LLMs) are Artificial Intelligence (AI) models designed to understand and generate human language. These models can perform language-related tasks, such as translation, summarization, and conversation. The surge in the use of LLMs has caught the attention of many industries and sectors, thanks to their many uses. However, a fundamental issue in exploiting their abilities is creating user confidence in their produced outputs.

LLM automatic evaluation plays a significant role for users to track model performance, validation model version updates, model selection, etc. LLM automatic evaluation assesses the performance and quality of responses generated by LLMs without human intervention to ensure the LLMs produce high-quality, relevant, and consistent responses.

LLM automatic evaluation metrics are proposed to measure various perspectives of the output quality. Objective computational metrics like Rouge, BLEU, BertScore, MoverScore, Prism, BartScore, among others, gauge the efficiency of the LLM models. Moreover, recently subjective metric scores generated by an LLM-as-judge are also proposed to measure detailed, specific perspectives of the output quality according to specific application requirements. Most of these metric scores, including both the objective and subjective ones, are real number values. To facilitate decision-making, the metric scores usually need to be binarized (good/bad, pass/fail, accept/reject). A pre-defined fixed threshold value is often required to accomplish the binarization of a metric. Currently, these thresholds are specified heuristically according to experience, which cannot eliminate the systematical variance of metric value distribution difference and application requirement difference.

In other words, as the usage of LLMs increases, automatically evaluating different LLM models, model versions, prompts, etc. for different applications becomes increasingly important for performance tracking, model version validation, prompt comparison, model selection, etc. In LLM automatic evaluation, many metrics have been proposed to measure the output quality from different perspectives. Usually, a pre-defined threshold is required to represent the acceptance bar for the corresponding perspective of quality measured by the specific metric. In current practice, users specify the thresholds arbitrarily or heuristically. In most cases, heuristic threshold selection is not effective.

For example, different metrics usually originate from different theories, and thus produce different value ranges, scales, and distributions. Therefore, it is difficult to explain the meaning of the threshold value, especially to users. Also, different user applications often have different requirements, such as acceptance bars, for different metrics. Furthermore, users have better knowledge of the requirements than developers. On the other hand, developers have better knowledge of the theoretical background of metrics. It is very costly to reach an effective threshold to bridge between the metric values and application requirements by manual communications. Additionally, users cannot easily quantify the acceptance bar, especially when results are subjective, such as a desired format of output data, which may not be easily quantified. If users are asked to define the acceptance bar, they are typically unable to give a clear definition. Furthermore, inaccurate thresholds and attempts to produce more accurate thresholds result in inefficient processing of data, which results in wasted processing power. Also, incorrect thresholds result in inefficient grading engines that further waste processing power.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIGS. 1 and 2 provide an illustration of automatic evaluation of a first ML model according to an example embodiment.

FIG. 3 is an illustration of a metric score calibration according to an example embodiment.

FIG. 4 is an illustration of metric score calibration according to an example embodiment.

FIG. 5 is a flowchart of a method of machine learning automatic evaluation threshold calibration according to an example embodiment.

FIG. 6 is a block diagram that illustrates a computer system upon which aspects of the illustrative embodiments may be implemented.

FIG. 7 is a block diagram of a basic software system that may be employed for controlling the operation of a computer system to implement aspects of the illustrative embodiments.

FIG. 8 is a block diagram that illustrates a computer system upon which aspects of the illustrative embodiments may be implemented.

FIG. 9 is a block diagram of a basic software system that may be employed for controlling the operation of a computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

To overcome the aforementioned issues, embodiments provide ML-based automatic evaluation threshold calibration. In particular, embodiments provide a systematic threshold calibration approach based on statistical ML. A set of human-annotated data with binary labels (e.g., “pass/fail”) is collected for each specific evaluation metric. The set can be a small set of annotated data. The threshold-determining problem is then formulized as a binary classification problem where the threshold is optimized to predict human decisions (the binary labels). Support vector machines (SVMs) can be used to solve the threshold optimization problem because SVMs are effective and generalize well in small sample problems. Other ML models can also optimize the threshold. The obtained threshold represents the application requirements well with human alignment due to the use of human-annotated data. The approach is generic and can be applied to any real-valued metrics.

For example, at least some embodiments provide a systematic method to determine the optimal threshold for any specific metric (either objective or subjective). User application requirements are presented by asking users, such as subject matter experts (SMEs), product managers (PMs), etc., to annotate a small set of sample data with binary labels: pass/fail. The users judge by example instead of answering the general question about what the acceptance bar is. The users can easily express their requirements by judging by example. Thus, the annotated data effectively represents the user's application requirements. In this way, the user communication is decoupled from the task of generating a specific metric. After obtaining the representative annotated data, ML is leveraged to automatically learn the threshold. For example, the threshold finding problem is formulized as a binary classification problem. In an example embodiment, an SVM can be used to determine the threshold, because the data size is typically small and an SVM is effective to obtain generalizable solutions on small sample learning problems. Other ML models can also be used to determine the threshold.

Embodiments can provide generative AI automatic evaluation threshold calibration with human alignments. Users are confident in the chosen ML model because the results align with their requirements.

At least some embodiments further provide systematic methods that determine thresholds for automatic evaluation metrics. The methods produce thresholds that represent application requirements better than existing threshold-determining approaches that are based on manual heuristic selection. Moreover, the methods may only require a small amount of annotated data, which improves processor efficiency and minimizes processing time, memory requirements, and human effort.

At least some embodiments formulize the automatic evaluation metric threshold finding problem as a 1-dimensional binary classification problem and leverage ML algorithms to automatically learn the application requirements from human-annotated data. The methods are derived from a strong theoretical foundation and are thus more effective and accurate than manual heuristic threshold selection.

Since the problem can be a typical small-sample ML problem, an SVM can be employed as a vehicle to optimize the automatic evaluation metric threshold. The trained SVM may not be directly applied to classify the metric value to pass/fail labels but can be distilled into threshold values that are required and ready to be used by the automatic evaluation framework. Due to the small-sample classification capability of SVM, only a small volume of samples needs to be annotated by users. This small volume increases processor and memory efficiency and is also effective and cost-efficient for users.

Embodiments can represent application requirements as a small size human-annotated dataset, which significantly reduces the need for communication between developers and users. The obtained thresholds are aligned with application requirements because users can easily and effectively label example outputs.

Embodiments are more effective than existing threshold-finding methods, due to application requirement representation by human annotation, and the utilization of an ML method to solve the problem of finding the threshold.

Embodiments also provide general methods for determining thresholds and thus can be applied to any kind of real-valued metrics, ready to be plugged into any automatic evaluation framework. For example, embodiments can be applied to LLM automatic evaluation, generative AI automatic evaluation, non-ML evaluation, and other evaluation frameworks.

Embodiments are also efficient because annotating a small set of representative examples is easier and more effective than manual communications between developers and users. Therefore, embodiments save time and effort for both developers and users. The use of a small set of examples also improves processor efficiency and reduces memory usage.

The threshold is obtained by ML methods that are systematically derived from a solid theoretical ground. This makes it easier for developers and users to reach agreements on the resultant threshold than from manual communications and negotiations of the threshold.

### Model Automatic Evaluation

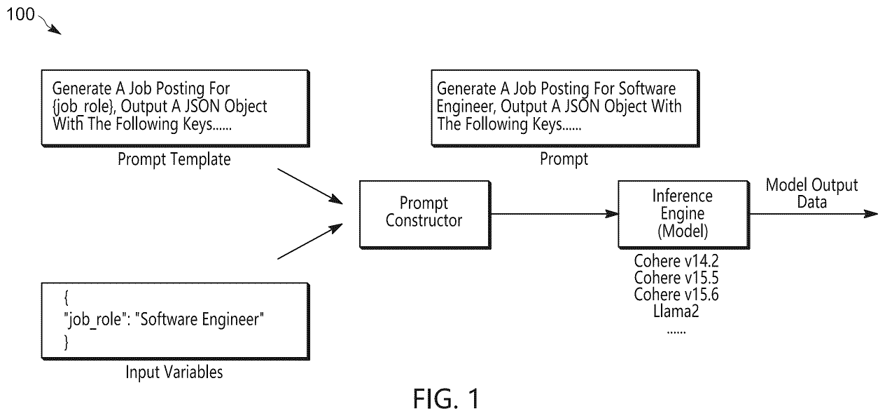

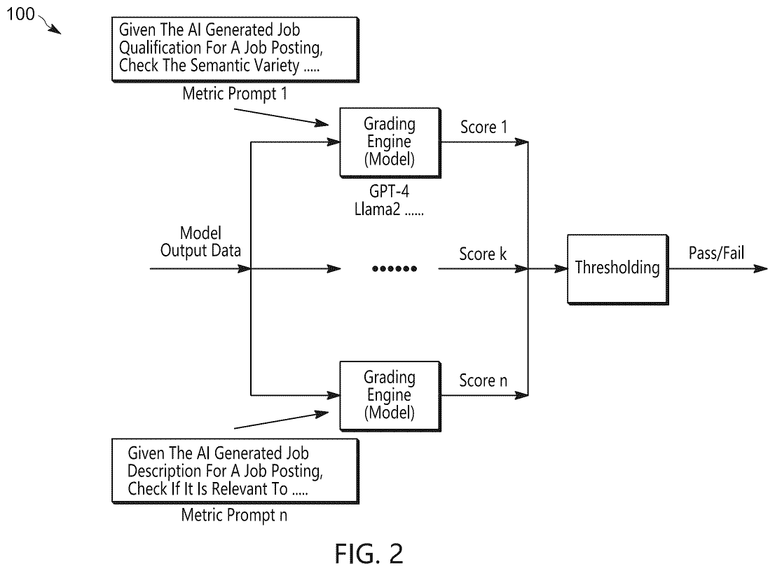

FIGS. 1 and 2 provide an illustration of automatic evaluation 100 of a first ML model according to an example embodiment. The automatic evaluation can be for different use cases, such as applications, that employ the first ML model. The first ML model can be an inference engine, such as an LLM, Natural Language Processing (NLP), a version of Cohere, Llama, or any other ML model.

In operation, a prompt constructor receives data. The received data can include a prompt template that provides instructions for asking the first ML model to generate first ML model output data, such as content or other ML output data. For example, the received data can be a prompt template for a request to generate a job posting for a particular job role and output a JSON object with certain keys. The received data also includes input variables, such as a job role of a software engineer and other variables specified by an end user. Another end user may provide different input variables, such as a different job role of a data scientist and other related information. The prompt constructor generates a prompt based on the received data and provides the prompt to the first ML model. The first ML model completes the generation of the model output data and provides the completed model output data to second ML models, such as grading engines.

The grading engines can be LLMs, such as GPT-4, Llama2, or other grading engines. The grading engines evaluate how the first ML model performed on a particular use case, such as for a job posting for a software engineer. In an embodiment, the grading engines perform evaluations of different first ML models for the same use case based on desired grading requirements. For example, users can provide different acceptance criteria/requirements. Metric prompts are provided to the grading engines to evaluate the quality of the content based on the acceptance criteria/requirements. In particular, the metric prompt instructs the grading engine to grade the content. Different grading engines can use different metric prompts to evaluate different metrics, such as semantic variety, relevancy, accuracy, fluency, completeness, and other metrics. A job description can include a list of qualifications and responsibilities, and different grading engines evaluate the quality of the corresponding content based on different metrics, such as semantic variety and relevancy.

Each grading engine provides a score for each metric based on the grading engine evaluation. Thresholding applies a threshold to each metric score to binarize the result as pass or fail. If all metrics pass, the thresholding provides an overall pass result for the model output data. The evaluation process of grading and thresholding is repeated for different model output data content from the first ML model, which produces a pass rate for the first ML model. If the pass rate of the first ML model is above a desired threshold, such as when a majority of the model output data content passes, a determination is made that the first ML model produces a desired quality of the content.

### Metric Score Threshold Calibration

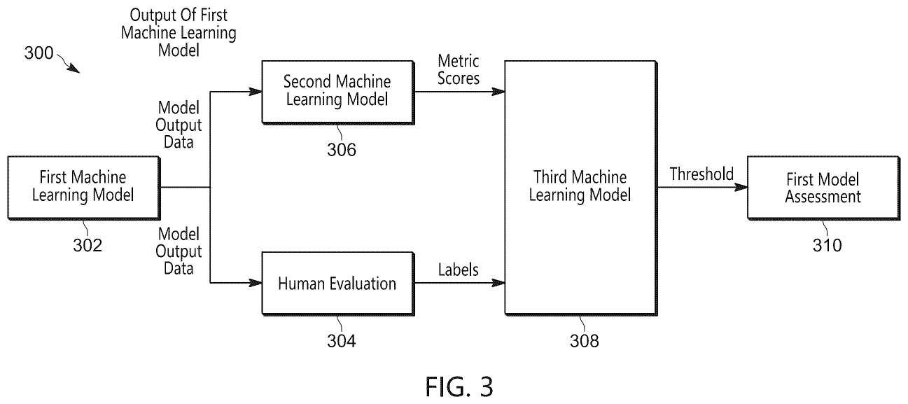

FIG. 3 is an illustration of a metric score calibration 300 according to an example embodiment. The metric score calibration 300 improves the efficiency of the automatic evaluation 100 of models for different use cases. The metric score calibration 300 can include a first ML model 302, human evaluation 304, a second ML model 306, a third ML model 308, and a first ML model assessment 310. As discussed above, the first ML model 302 can be an inference engine or other model and the second ML model 306 can be a grading engine or other ML model.

As described above, issues arise when determining the thresholds for the metric scores from each grading engine. For example, users and developers may not be able to properly establish the thresholds. To address the issues threshold finding can be accomplished by the following process:
1. Collect first ML model output data that is representative of a specific metric.
2. Annotators, such as SMEs, PMs, and/or other users, perform human evaluation and label each first ML model output as “pass” or “fail” based on the specific metric.
3. The second ML model 306 scores the first ML model outputs using auto-evaluation metrics to provide automatic evaluation metric scores.
4. The third ML model 308 generates the threshold based on the human-generated labels and the automatic evaluation metric scores. The threshold finding can be metric-wise, which focuses on a specific metric at a time.

In an implementation, the threshold calibration problem is formulized as a binary classification problem. The automatic evaluation metric scores as features and the annotated “pass” or “fail” labels are fit to a one-dimensional linear Support Vector Classifier (SVC). The threshold is determined as b/w, where ‘b’ represents the intercept and ‘w’ represents the coefficient of the binary classification plane of the linear SVC. Because the threshold finding is metric-wise, the metric score is a 1-dimensional feature, and the problem is a 1-dimensional binary classification that optimizes a function f(x)=ax+b from the data, as discussed further below, where ‘b’ represents the intercept and ‘a’ represents the coefficient in this equation. Example details of the operation are provided below.

### Human Annotation

Representative examples output from the first ML model 302 are collected and human annotators are asked to label each example with “pass”/“fail” to provide the human evaluation 304 The examples focus on a specific target metric, which means another aspect of the data should not affect the decision making for annotators. For example, if the chosen target metric is variety, then the natural language quality (nlquality) should be good for all data. Users may typically find it difficult to quantify their requirements. However, the use of examples allows the users to easily judge the examples and annotate them as passing or failing their requirements. A small number of samples can be used to improve the efficiency of collecting the annotation labels by making it easier for the users to provide the labels.

### Automatic Evaluation Metric Scoring

The second ML model 306 performs automatic evaluation metric analysis for each of the example output data to obtain corresponding automatic evaluation metric scores. For example, a grading engine evaluates the output data based on desired grading requirements and provides an automatic evaluation score for the target metric for each output example. As discussed above, the metric calibration process can be metric-wise, which means one metric is focused on at a time.

### Metric Score Threshold Finding

The third ML model 308 generates an automatic evaluation metric score threshold based on the human-generated labels and the automatic evaluation metric scores. The threshold is the bridge to calibrate automatic evaluation metric grading (e.g., ROUGE score, BERT score, or subjective metrics graded by GPT-4) with human grading. For the given metric score, the pass/fail decision produced by the threshold will be aligned with human evaluation.

In a possible embodiment, to generate the automatic evaluation metric score threshold, the problem is formulated as a binary classification problem. On one hand, the human-annotated “pass”/“fail” labels are the ground-truth labels. On the other hand, the scores graded by automatic evaluation are the features. The third ML model 308 can be a classifier that is fit with one parameter: the threshold, because the feature is metric-wise/1-dimensional, to maximize the “pass”/“fail” accuracy. Specifically, the threshold determination problem can be a 1-dimensional binary classification problem considering the whole process is conducted metric-wise, and it makes sense to assume the classification function is linear considering the meaning of metric scores. Several methods, such as direct search, Linear Discriminant Analysis (LDA), SVM, adaptive boosting, and other methods can also be employed for the third ML model 308 to address the classification problem.

Direct search employs a linear fixed step search or a binary search, where the parameter space is sampled, and the best value is found in the sample. This can be easy to implement but may not find the optimum solution when the training dataset is small. Also, the model output data often has noise, such as errors, which can result in the direct search not providing an optimal solution.

LDA assumes both the distribution of “pass” class and “fail” class are Gaussian distributed in feature space and finds the Bayesian-optimal solution of the parameters as the threshold. This can produce one optimum solution if a Gaussian assumption is satisfied and sufficient model output data is available, but the Gaussian assumption may not be satisfied. Also, the model output data annotation is costly, and it may not be feasible to obtain sufficient data to estimate the Gaussian parameters.

Another method for the third ML model 308 uses linear SVMs. Based on a maximum-margin classification hyper-plane assumption, the hinge loss is optimized together with an additional regularization term to find the parameters. This method produces one optimum solution based on maximum-margin assumption and the maximum-margin is a very soft constraint, which can make sense in most cases. This method also works well with small-size training data, such as the small samples used to generate the metric threshold. For example, a SWM may require 10× less data than other methods.

The SVM is fed with the data, which gives the model parameters of the SVM. The threshold is then extracted from the model parameters. In particular, the whole linear SVM classifier does not need to be stored and applied directly. Because only the threshold is needed, the 1-dimensional linear SVM is reduced into a single threshold number. The 1-dimensional linear SVM contains two parameters: the coefficient and the intercept, which are scalars. The threshold is then calculated as: threshold=−1*intercept/coefficient.

### Edge Cases

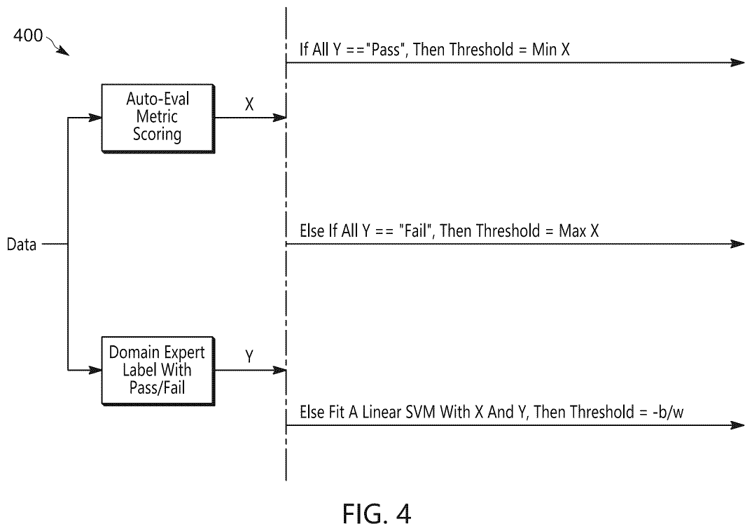

FIG. 4 is an illustration of metric score calibration 400 according to an example embodiment. As discussed above, the threshold finding is metric-wise treating each metric separately, the metric score, X, is a 1-dimensional feature, and the problem is a 1-dimensional binary classification which optimizes a function f(x)=ax+b from the data.

The human-annotated “pass”/“fail” labels are the ground-truth labels, Y. The scores graded by automatic evaluation are the features, X. An edge case occurs when the training data are all labeled “pass” or all labeled “fail.” If all labels are “pass”, then the minimum value of the automatic-evaluation metrics score is used as the threshold. If all labels are “fail,” then the maximum value of the automatic-evaluation metric scores is used as the threshold. If all the labels are neither pass nor fail, the third ML model is used to determine the threshold. For example, a linear SVM is fit with the labels Y and the features X, and the threshold is determined based on-b/w, as described above. Put these pieces together, an example threshold finding algorithm can be described as:

```
from sklearn.svm import LinearSVC
# X is metric scores of all data point
# Y is the human annotated labels of all data points: 1 stands for “pass”, 0
stands for “fail”
def find_thresh(X, Y):
  if sum(Y) == len(Y):
    return min(X)
  if sum(Y) == 0:
    return max(X)
  X = np.array(X, dtype=float).reshape(−1, 1)
  Y = np.array(Y, dtype=int)
  model = LinearSVC(dual=False, C=100)
  model.fit(X, Y)
  thresh = -model.intercept_ / model.coef_{—}
```

The algorithm finds the model parameters, which are the model intercept and model coefficient, which describe a classification plane. Because this is a 1-dimensional problem, the threshold can just be based on the intercept divided by the coefficient.

The labels can be provided by one or more annotators. When multiple annotators provide labels, there may be instances where all the labels do not match, such as two indicating pass while another indicates fail. Some types of models, such as SVM, can tolerate noise. Alternatively, when there are such discrepancies, the mismatched set of labels may be thrown out or the majority may control the result.

### Example Results

In a first example, a prompt was provided to a first ML model to generate development tips. The example prompt was:

```
Suggest a numbered list of 5 unique development tips for increasing an employee's proficiency
for the following competency:
<competency>
competency name: Analysis and Problem Solving
competency description: Able to identify and separate out the key components of problems
and situations. Able to manipulate and interpret information from a range of sources, to spot
patterns and trends in information and to deduce cause and effect from this. Can generate a
range of creative solutions, evaluate them and choose the most appropriate option.
</competency>
System: output as a JSON array that includes the following keys: header, developmentTips.
System: the JSON output should follow this format:
{
  “header”: “<insert header>”,
  “developmentTips”: [
      {
          “tip”: “1. <insert unique specific tip name>”,
          “description”: “<insert detailed tip description with no more than 100 words>”
      },
      {
          “tip”: “2. <insert unique specific tip name>”,
          “description”: “<insert detailed tip description with no more than 100 words>”
      },
        ...
      {
          “tip”: “5. <insert unique specific tip name>”,
          “description”: “<insert detailed tip description with no more than 100 words>”
      }
    ]
}
System: output JSON content only, do not add extra text.
```

An example first completed output of the first ML model was:

```
{
  “header”: “5 Tips to Improve in Analysis and Problem Solving”,
  “developmentTips”: [
    {
      “tip”: “1. Enhance Your Data Skills”,
      “description”: “Develop expertise in handling and analyzing data using tools like
Excel, SQL, and data visualization software. Proficiency in these tools will enable you to
process and interpret large datasets, identify trends, and extract valuable insights.”
    },
    {
      “tip”: “2. Break Down Complex Problems”,
      “description”: “When faced with a complex problem, practice decomposing it into
smaller, more manageable components. This approach makes the problem less daunting and
helps you identify the root causes, which is crucial for an effective solution.”
    },
    {
      “tip”: “3. Learn from Past Cases”,
      “description”: “Study previous cases within your industry or domain that required
analytical problem-solving. Understand the approaches used, the decisions made, and the
outcomes. This knowledge can provide valuable insights when tackling similar problems.”
    },
    {
      “tip”: “4. Practice Logical Reasoning”,
      “description”: “Enhance your ability to think logically and systematically. Train your
mind to consider multiple variables, draw connections, and evaluate cause-and-effect
relationships. This helps you make sound decisions based on logical reasoning rather than
intuition alone.”
    },
    {
      “tip”: “5. Brainstorm and Ideate”,
      “description”: “Stimulate creativity by brainstorming different solutions to a problem.
Encourage yourself to come up with diverse solutions, even if they seem unconventional. This
exercise expands your thinking horizons and can lead to innovative solutions.”
    }
  ]
}
```

Three annotators reviewed various outputs, and each annotator provided a human-generated label for the variety of each output. A second ML model, such as a grading engine, provided an automatic evaluation metric score for the variety of each output. The following table shows the annotator labels and the metric scores.

| | | | | Variety Score |
|---|---|---|---|---|
| | | | | from Auto- |
| Output | Annotator 1 | Annotator 2 | Annotator 3 | eval |
| 1 | Pass | Pass | Pass | 0.4 |
| 2 | Pass | Pass | Pass | 0.6 |
| 3 | Pass | Pass | Pass | 0.6 |
| 4 | Pass | Pass | Pass | 0.6 |
| 5 | Pass | Pass | Pass | 0.6 |
| 6 | Pass | Pass | Pass | 0.4 |
| 7 | Pass | Pass | Pass | 0.6 |
| 8 | Pass | Pass | Pass | 0.4 |
| 9 | Pass | Pass | Pass | 0.6 |
| 10 | Pass | Pass | Pass | 0.8 |

Using the threshold finding algorithm above, a third ML model provided an automatic evaluation metric score threshold=0.4 for variety with precision=1.0 and recall=1.0.

In a second example, another prompt was provided to the first ML model for goal creation. Three annotators reviewed various outputs, and each annotator provided a human-generated label for variety in sentence structure of each output. The second ML model provided an automatic evaluation metric score for the variety in sentence structure of each output. The following table shows the annotator labels and the metric scores.

| | | Variety in Sentence |
|---|---|---|
| | | Structure Score |
| Output | Annotator Labels | from Auto-eval |
| 1 | Fail, Fail, Fail | 0.4 |
| 2 | Pass, Pass, Pass | 0.7 |
| 3 | Pass, Pass, Pass | 0.4 |
| 4 | Pass, Pass, Pass | 0.4 |
| 5 | Fail, Fail, Fail | 0.4 |
| 6 | Pass, Pass, Pass | 0.4 |
| 7 | Pass, Pass, Pass | 0.6 |
| 8 | Pass, Pass, Pass | 0.6 |
| 9 | Pass, Pass, Pass | 0.6 |
| 10 | Pass, Pass, Pass | 0.4 |

Using the threshold finding algorithm above, the third ML model provided an automatic evaluation metric score threshold −0.3 for variety in sentence structure with precision=0.8 and recall=1.0. To obtain the threshold, the algorithm can use the sample data, assuming there is some distribution of the scores, and make the best guess as to the metric score threshold.

In a third example, another prompt was provided to the first ML model to generate candidate experience. Three annotators reviewed various outputs, and each annotator provided a human-generated label for the completeness of each output. The second ML model provided an automatic evaluation metric score for the completeness of each output. The following table shows the annotator labels and the metric scores.

| | | Completeness |
|---|---|---|
| | Annotator | Score from |
| Output | Labels | Auto-eval |
| 1 | Fail, Fail, Fail | 0.4 |
| 2 | Pass, Pass, Pass | 0.8 |
| 3 | Fail, Fail, Fail | 0.4 |
| 4 | Pass, Pass, Pass | 0.6 |
| 5 | Pass, Pass, Pass | 0.7 |
| 6 | Pass, Pass, Pass | 0.8 |
| 7 | Pass, Pass, Pass | 0.7 |
| 8 | Pass, Pass, Pass | 0.7 |
| 9 | Pass, Pass, Pass | 0.8 |
| 10 | Fail, Fail, Fail | 0.4 |

Using the threshold finding algorithm above, the third ML model provided an automatic evaluation metric score threshold=0.5 for completeness with precision=1.0 and recall=1.0.

### Machine Learning Automatic Evaluation Threshold Calibration Operation

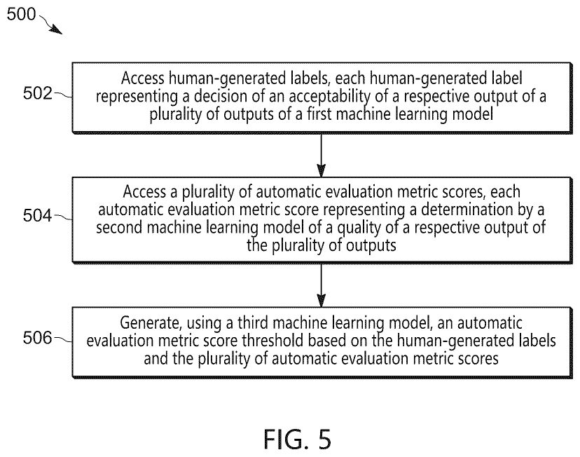

FIG. 5 is a flowchart 500 of a method of machine learning automatic evaluation threshold calibration according to an example embodiment. The method can be performed by one or more computing devices. At 502, the method includes accessing human-generated labels, each human-generated label representing a decision of acceptability of a respective output of a plurality of outputs of a first ML model. The labels can be binary and/or non-binary. At 504, the method includes accessing a plurality of automatic evaluation metric scores, each automatic evaluation metric score representing a determination by a second ML model of a quality of a respective output of the plurality of outputs. At 506, the method includes generating, using a third ML model, an automatic evaluation metric score threshold based on the human-generated labels and the plurality of automatic evaluation metric scores. In a possible implementation, the method includes assessing the output quality of a particular output of the first ML model based on comparing a subsequent automatic evaluation metric score of the second ML model to the automatic evaluation metric score threshold.

In a possible implementation, the method includes collecting a plurality of target metric-focused outputs that focus on a target metric while satisfying other metrics for the first ML model. The human-generated labels and the plurality of automatic evaluation metric scores correspond to the target metric. In an example, the target metric is a first target metric and the automatic evaluation metric score threshold is a first automatic evaluation metric score threshold. The method includes collecting a plurality of second target metric-focused outputs that focus on a second target metric. The also method includes accessing second human-generated labels corresponding to the second target metric and accessing a second plurality of automatic evaluation metric scores corresponding to the second target metric. The further method includes generating a second automatic evaluation metric score threshold based on the second human-generated labels and the second plurality of automatic evaluation metric scores corresponding to the second target metric.

In a possible implementation, the human-generated labels are a plurality of human-generated binary labels for each output of the plurality of outputs of the first ML model. For example, pass/fail decisions from one or more experts may be used for the human-generated labels for each output of the first ML model.

In a possible implementation, the method includes determining a plurality of the human-generated labels for a particular output of the first ML model do not match. The method includes in response to determining the plurality of the human-generated labels for a particular output do not match, performing: setting of a label for the particular output based on a majority of matching human-generated labels for the particular output, or discarding of the human-generated labels for a particular output.

In a possible implementation, the third ML model is an SVC including a coefficient parameter and an intercept parameter. The automatic evaluation metric score threshold is based on the coefficient parameter and the intercept parameter.

In a possible implementation, generating the automatic evaluation metric score threshold includes training the third ML model using the human-generated labels as labels and the plurality of automatic evaluation metric scores as features. Generating the automatic evaluation metric score threshold includes generating, using the trained third ML model, the automatic evaluation metric score threshold for use with the second ML model to assess an output quality of the first ML model.

In a possible implementation, the human-generated labels are first human-generated labels, and the plurality of automatic evaluation metric scores are a plurality of first automatic evaluation metric scores. The method includes accessing second human-generated labels, each second human-generated label representing a decision of an acceptability of a respective output of a second plurality of outputs of a fourth ML model. The method also includes accessing a plurality of second automatic evaluation metric scores, each second automatic evaluation metric score representing a determination by a fifth ML model of a quality of a respective output of the second plurality of outputs of the fourth ML model. The method further includes setting a second automatic evaluation metric score threshold to a value of the plurality of second automatic evaluation metric scores in response to the second human-generated labels being the same for all of the outputs of the fourth ML model. The fourth ML model and the fifth ML model may be the same as, or different from, the respective first ML model and second ML model. For example, generation of the threshold using the third ML model can be bypassed and the threshold value can be set when the human-generated labels indicate the same decision for all outputs of the first ML model. This can handle edge cases when the training data are all labeled “pass,” or are all labeled “fail.”

In an example of this implementation, setting the second automatic evaluation metric score threshold includes setting an automatic evaluation metric score threshold to be a minimum value of the plurality of second automatic evaluation metric scores in response to the second human-generated labels indicating all of the outputs of the fourth ML model are acceptable. Alternatively, setting the second automatic evaluation metric score threshold includes setting an automatic evaluation metric score threshold to be a maximum value of the plurality of second automatic evaluation metric scores in response to the second human-generated labels indicating all of the outputs of the fourth ML model are not acceptable.

### Machine Learning Engine

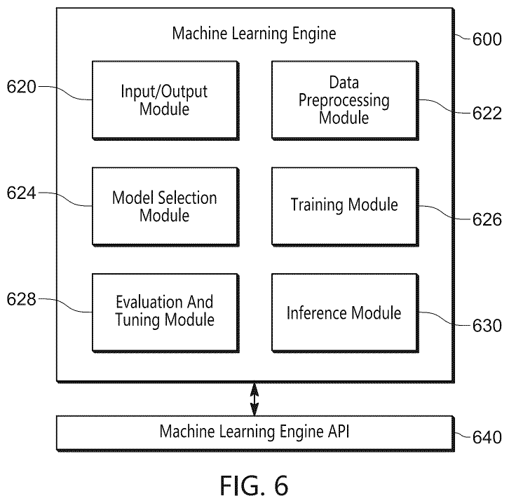

FIG. 6 illustrates a machine learning engine 600 in accordance with one or more embodiments. As illustrated in FIG. 6, machine learning engine 600 includes input/output module 620, data preprocessing module 622, model selection module 624, training module 626, evaluation and tuning module 628, and inference module 630.

In accordance with an embodiment, input/output module 620 serves as the primary interface for data entering and exiting the system, managing the flow and integrity of data. This module may accommodate a wide range of data sources and formats to facilitate integration and communication within the machine learning architecture.

In an embodiment, an input handler within input/output module 620 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 620 to be versatile in different operational contexts, whether processing historical datasets or streaming data.

In accordance with an embodiment, input/output module 620 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 620 includes an output framework designed to handle the distribution and exportation of outputs, predictions, or insights. Using the output framework, input/output module 620 formats these outputs into user-friendly and accessible formats, such as reports, visualizations, or data files compatible with other systems. Input/output module 620 also ensures secure and efficient transmission of these outputs to end-users or other systems in an embodiment and may employ encryption and secure data transfer protocols to maintain data confidentiality.

In accordance with an embodiment, data preprocessing module 622 transforms data into a format suitable for use by other modules in machine learning engine 600. For example, data preprocessing module 622 may transform raw data into a normalized or standardized format suitable for training ML models and for processing new data inputs for inference. In an embodiment, data preprocessing module 622 acts as a bridge between the raw data sources and the analytical capabilities of machine learning engine 600.

In an embodiment, data preprocessing module 622 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 622 may be configured to handle anomalies in different ways depending on context. Data preprocessing module 622 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 622 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 622 processes new data for inference, data preprocessing module 622 replicates the same preprocessing steps to ensure consistency with the training data format. This helps to avoid discrepancies between the training data format and the inference data format, thereby reducing the likelihood of inaccurate or invalid model predictions.

In an embodiment, model selection module 624 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 624 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 624 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 624 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 624 also considers computational efficiency and resource constraints. This is meant to help ensure the selected model is both accurate and practical in terms of computational and time requirements. In an embodiment, certain features of model selection module 624 are configurable such as a configured bias toward (or against) computational efficiency.

In accordance with an embodiment, training module 626 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 626 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 626 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 626 includes logic to handle different types of data and learning tasks. For instance, it includes different training routines for supervised learning (where the training data comes with labels) and unsupervised learning (without labeled data). In the case of deep learning models, training module 626 also manages the complexities of training neural networks that include initializing network weights, choosing activation functions, and setting up neural network layers.

In an embodiment, evaluation and tuning module 628 incorporates dynamic feedback mechanisms and facilitates continuous model evolution to help ensure the system's relevance and accuracy as the data landscape changes. Evaluation and tuning module 628 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 628 performs continuous model tuning by using hyperparameter optimization. Evaluation and tuning module 628 performs an exploration of the hyperparameter space using algorithms, such as grid search, random search, or more sophisticated methods like Bayesian optimization. Evaluation and tuning module 628 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 628 integrates data feedback and updates the model. Evaluation and tuning module 628 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 628 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 628 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 630 transforms data raw data into actionable, precise, and contextually relevant predictions. In addition to processing and applying a trained model to new data, inference module 630 may also include post-processing logic that refines the raw outputs of the model into meaningful insights.

In an embodiment, inference module 630 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 630 transforms the outputs of a trained model into definitive classifications. Inference module 630 employs the underlying model as a tool to generate probabilistic outputs for each potential class. It then engages in an interpretative process to convert these probabilities into concrete class labels.

In an embodiment, when inference module 630 receives the probabilistic outputs from the model, it analyzes these probabilities to determine how they are distributed across some or every potential class. If the highest probability is not significantly greater than the others, inference module 630 may determine that there is ambiguity or interpret this as a lack of confidence displayed by the model.

In an embodiment, inference module 630 uses thresholding techniques for applications where making a definitive decision based on the highest probability might not suffice due to the critical nature of the decision. In such cases, inference module 630 assesses if the highest probability surpasses a certain confidence threshold that is predetermined based on the specific requirements of the application. If the probabilities do not meet this threshold, inference module 630 may flag the result as uncertain or defer the decision to a human expert. Inference module 630 dynamically adjusts the decision thresholds based on the sensitivity and specificity requirements of the application, subject to calibration for balancing the trade-offs between false positives and false negatives.

In accordance with an embodiment, inference module 630 contextualizes the probability distribution against the backdrop of the specific application. This involves a comparative analysis, especially in instances where multiple classes have similar probability scores, to deduce the most plausible classification. In an embodiment, inference module 630 may incorporate additional decision-making rules or contextual information to guide this analysis, ensuring that the classification aligns with the practical and contextual nuances of the application.

In regression models, where the outputs are continuous values, inference module 630 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 630 incorporates domain-specific adjustments into its post-processing routine. This involves tailoring the model's output to align with specific industry knowledge or contextual information. For example, in financial forecasting, inference module 630 may adjust predictions based on current market trends, economic indicators, or recent significant events, ensuring that the outputs are both statistically accurate and practically relevant.

In an embodiment, inference module 630 includes logic to handle uncertainty and ambiguity in the model's predictions. In cases where inference module 630 outputs a measure of uncertainty, such as in Bayesian inference models, inference module 630 interprets these uncertainty measures by converting probabilistic distributions or confidence intervals into a format that can be easily understood and acted upon. This provides users with both a prediction and an insight into the confidence level of that prediction. In an embodiment, inference module 630 includes mechanisms for involving human oversight or integrating the instance into a feedback loop for subsequent analysis and model refinement.

In an embodiment, inference module 630 formats the final predictions for end-user consumption. Predictions are converted into visualizations, user-friendly reports, or interactive interfaces. In some systems, like recommendation engines, inference module 630 also integrates feedback mechanisms, where user responses to the predictions are used to continually refine and improve the model, creating a dynamic, self-improving system.

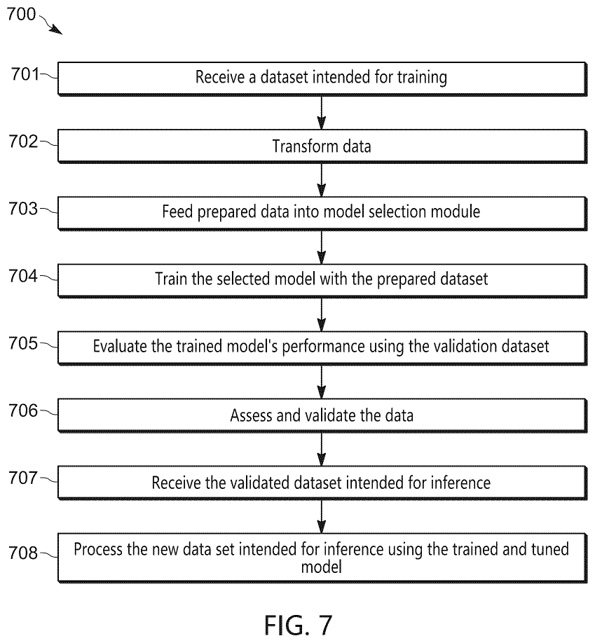

FIG. 7 illustrates the operation 700 of a machine learning engine in one or more embodiments. In an embodiment, input/output module 620 receives a dataset intended for training (Operation 701). This data can originate from diverse sources, like databases or real-time data streams, and in varied formats, such as CSV, JSON, or XML. Input/output module 620 assesses and validates the data, ensuring its integrity by checking for consistency, data ranges, and types.

In an embodiment, training data is passed to data preprocessing module 622. Here, the data undergoes a series of transformations to standardize and clean it, making it suitable for training ML models (Operation 702). This involves normalizing numerical data, encoding categorical variables, and handling missing values through techniques like imputation.

In an embodiment, prepared data from the data preprocessing module 622 is then fed into model selection module 624 (Operation 703). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 626 trains the selected model with the prepared dataset (Operation 704). It implements learning algorithms to adjust the model's internal parameters, optimizing them to identify patterns and relationships in the training data. Training module 626 also addresses the challenge of overfitting by implementing techniques, like regularization and early stopping, ensuring the model's generalizability.

In an embodiment, evaluation and tuning module 628 evaluates the trained model's performance using the validation dataset (Operation 705). Evaluation and tuning module 628 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 620 receives a dataset intended for inference. Input/output module 620 assesses and validates the data (Operation 706).

In an embodiment, data preprocessing module 622 receives the validated dataset intended for inference (Operation 707). Data preprocessing module 622 ensures that the data format used in training is replicated for the new inference data, maintaining consistency and accuracy for the model's predictions.

In an embodiment, inference module 630 processes the new data set intended for inference, using the trained and tuned model (Operation 708). It applies the model to this data, generating raw probabilistic outputs for predictions. Inference module 630 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 640 allows for applications to leverage machine learning engine 600. In an embodiment, machine learning engine API 640 may be built on a RESTful architecture and offer stateless interactions over standard HTTP/HTTPS protocols. Machine learning engine API 640 may feature a variety of endpoints, each tailored to a specific function within machine learning engine 600. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 640 is equipped to support SOAP-based interactions. This extension involves defining a WSDL (Web Services Description Language) document that outlines the API's operations and the structure of request and response messages. In an embodiment, machine learning engine API 640 supports various data formats and communication styles. In an embodiment, machine learning engine API 640 endpoints may handle requests in JSON format or any other suitable format. For example, machine learning engine API 640 may process XML, and it may also be engineered to handle more compact and efficient data formats, such as Protocol Buffers or Avro, for use in bandwidth-limited scenarios.

In an embodiment, machine learning engine API 640 is designed to integrate WebSocket technology for applications necessitating real-time data processing and immediate feedback. This integration enables a continuous, bi-directional communication channel for a dynamic and interactive data exchange between the application and machine learning engine 600.

### Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 620, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 622 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 624, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 626, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 628 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 630, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

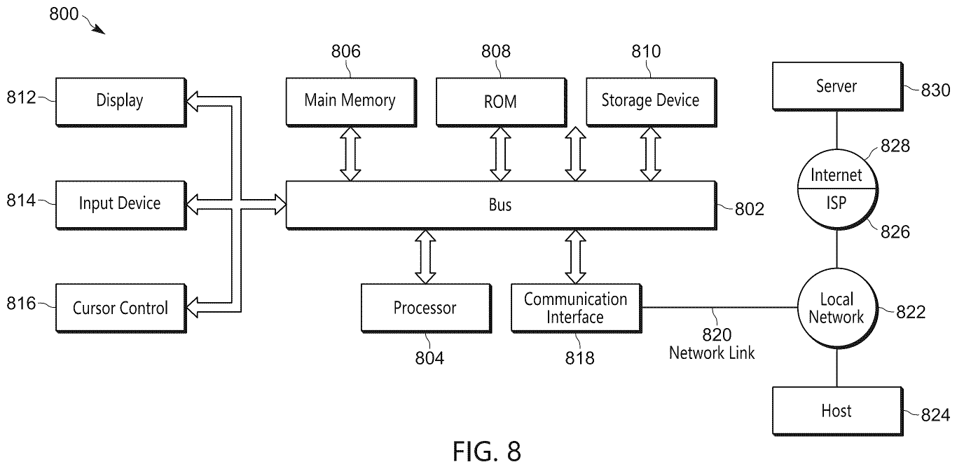

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812 for displaying information to a computer user. An input device 814, including alphanumeric and other keys, is coupled to bus 802 for communicating information and command selections to processor 804. Another type of user input device is cursor control 816, such as a mouse, a trackball, a touch screen, a track pad, and/or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 800 can receive the data and use, for an example, an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented, such as to a wireless local area network (WLAN) or to a cellular network. In any such implementation, communication interface 818 sends and receives electrical, electromagnetic, radio, optical, and/or other signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Over View

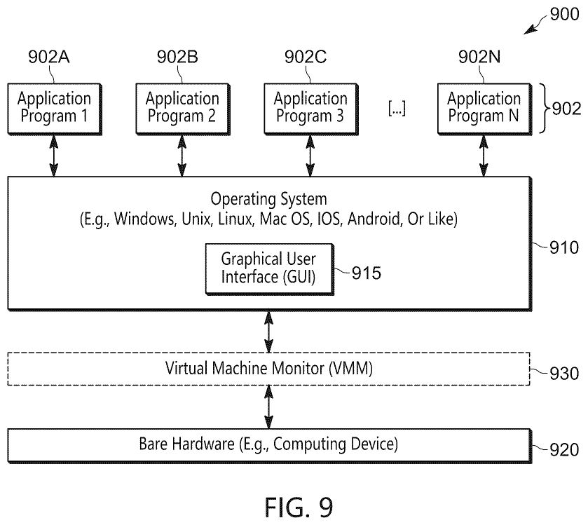

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
accessing human-generated labels, each human-generated label representing a decision of an acceptability of a respective output of a plurality of outputs of a first machine learning model;
accessing a plurality of automatic evaluation metric scores, each automatic evaluation metric score representing a determination, by a second machine learning model, of a quality of a respective output of the plurality of outputs; and
generating, using a third machine learning model, an automatic evaluation metric score threshold based on the human-generated labels and the plurality of automatic evaluation metric scores,
wherein the method is performed by one or more computing devices.

2. The method of claim 1, further comprising assessing an output quality of a particular output of the first machine learning model based on comparing a subsequent automatic evaluation metric score of the second machine learning model to the automatic evaluation metric score threshold.

3. The method of claim 1, further comprising collecting a plurality of target metric-focused outputs that focus on a target metric while satisfying other metrics for the first machine learning model,
where the human-generated labels and the plurality of automatic evaluation metric scores correspond to the target metric.

4. The method of claim 3,
wherein the target metric comprises a first target metric and the automatic evaluation metric score threshold comprises a first automatic evaluation metric score threshold,
wherein the method further comprises:
collecting a plurality of second target metric-focused outputs that focus on a second target metric;
accessing second human-generated labels corresponding to the second target metric;
accessing a second plurality of automatic evaluation metric scores corresponding to the second target metric; and
generating a second automatic evaluation metric score threshold based on the second human-generated labels and the second plurality of automatic evaluation metric scores corresponding to the second target metric.

5. The method of claim 1, where the human-generated labels comprise a plurality of human-generated binary labels for each output of the plurality of outputs of the first machine learning model.

6. The method of claim 5, further comprising:
determining a plurality of the human-generated labels for a particular output of the first machine learning model do not match; and
in response to determining the plurality of the human-generated labels for a particular output do not match:
setting a label for the particular output based on a majority of matching human-generated labels for the particular output, or
discarding the human-generated labels for a particular output.

7. The method of claim 1, wherein the third machine learning model comprises a support vector classifier comprising a coefficient parameter and an intercept parameter, where the automatic evaluation metric score threshold is based on the coefficient parameter and the intercept parameter.

8. The method of claim 1,
wherein generating the automatic evaluation metric score threshold comprises training the third machine learning model using
the human-generated labels as labels, and
the plurality of automatic evaluation metric scores as features,
wherein generating comprises generating, using the trained third machine learning model, the automatic evaluation metric score threshold for use with the second machine learning model to assess an output quality of the first machine learning model.

9. The method of claim 1,
wherein the human-generated labels comprise first human-generated labels and the plurality of automatic evaluation metric scores comprise a plurality of first automatic evaluation metric scores,
wherein the method further comprises:
accessing second human-generated labels, each second human-generated label representing a decision of an acceptability of a respective output of a second plurality of outputs of a fourth machine learning model;
accessing a plurality of second automatic evaluation metric scores, each second automatic evaluation metric score representing a determination, by a fifth machine learning model, of a quality of a respective output of the second plurality of outputs of the fourth machine learning model; and
setting a second automatic evaluation metric score threshold to a value of the plurality of second automatic evaluation metric scores in response to the second human-generated labels being the same for all of the outputs of the fourth machine learning model.

10. The method of claim 9, wherein setting the second automatic evaluation metric score threshold comprises:
setting an automatic evaluation metric score threshold to be a minimum value of the plurality of second automatic evaluation metric scores in response to the second human-generated labels indicating all of the outputs of the fourth machine learning model are acceptable; or
setting an automatic evaluation metric score threshold to be a maximum value of the plurality of second automatic evaluation metric scores in response to the second human-generated labels indicating all of the outputs of the fourth machine learning model are not acceptable.

11. One or more non-transitory storage media storing one or more sequences of instructions which, when executed by one or more computing devices, cause:
accessing human-generated labels, each human-generated label representing a decision of an acceptability of a respective output of a plurality of outputs of a first machine learning model;
accessing a plurality of automatic evaluation metric scores, each automatic evaluation metric score representing a determination, by a second machine learning model, of a quality of a respective output of the plurality of outputs; and
generating, using a third machine learning model, an automatic evaluation metric score threshold based on the human-generated labels and the plurality of automatic evaluation metric scores.

12. The one or more non-transitory storage media of claim 11, wherein the instructions include instructions for assessing an output quality of a particular output of the first machine learning model based on comparing a subsequent automatic evaluation metric score of the second machine learning model to the automatic evaluation metric score threshold.

13. The one or more non-transitory storage media of claim 11,
wherein the instructions include instructions for collecting a plurality of target metric-focused outputs that focus on a target metric while satisfying other metrics for the first machine learning model,
where the human-generated labels and the plurality of automatic evaluation metric scores correspond to the target metric.

14. The one or more non-transitory storage media of claim 13,
wherein the target metric comprises a first target metric and the automatic evaluation metric score threshold comprises a first automatic evaluation metric score threshold,
wherein the instructions include instructions for:
collecting a plurality of second target metric-focused outputs that focus on a second target metric;
accessing second human-generated labels corresponding to the second target metric;
accessing a second plurality of automatic evaluation metric scores corresponding to the second target metric; and
generating a second automatic evaluation metric score threshold based on the second human-generated labels and the second plurality of automatic evaluation metric scores corresponding to the second target metric.

15. The one or more non-transitory storage media of claim 11, where the human-generated labels comprise a plurality of human-generated binary labels for each output of the plurality of outputs of the first machine learning model.

16. The one or more non-transitory storage media of claim 15, wherein the instructions include instructions for:
determining a plurality of the human-generated labels for a particular output of the first machine learning model do not match; and
in response to determining the plurality of the human-generated labels for a particular output do not match:
setting a label for the particular output based on a majority of matching human-generated labels for the particular output, or
discarding the human-generated labels for a particular output.

17. The one or more non-transitory storage media of claim 11, wherein the third machine learning model comprises a support vector classifier comprising a coefficient parameter and an intercept parameter, where the automatic evaluation metric score threshold is based on the coefficient parameter and the intercept parameter.

18. The one or more non-transitory storage media of claim 11,
wherein generating the automatic evaluation metric score threshold comprises training the third machine learning model using
the human-generated labels as labels, and
the plurality of automatic evaluation metric scores as features,
wherein generating comprises generating, using the trained third machine learning model, the automatic evaluation metric score threshold for use with the second machine learning model to assess an output quality of the first machine learning model.

19. The one or more non-transitory storage media of claim 11,
wherein the human-generated labels comprise first human-generated labels and the plurality of automatic evaluation metric scores comprise a plurality of first automatic evaluation metric scores,
wherein the instructions include instructions for:
accessing second human-generated labels, each second human-generated label representing a decision of an acceptability of a respective output of a second plurality of outputs of a fourth machine learning model;
accessing a plurality of second automatic evaluation metric scores, each second automatic evaluation metric score representing a determination, by a fifth machine learning model, of a quality of a respective output of the second plurality of outputs of the fourth machine learning model; and
setting a second automatic evaluation metric score threshold to a value of the plurality of second automatic evaluation metric scores in response to the second human-generated labels being the same for all of the outputs of the fourth machine learning model.

20. The one or more non-transitory storage media of claim 19, wherein setting the second automatic evaluation metric score threshold comprises:
setting an automatic evaluation metric score threshold to be a minimum value of the plurality of second automatic evaluation metric scores in response to the second human-generated labels indicating all of the outputs of the fourth machine learning model are acceptable; or
setting an automatic evaluation metric score threshold to be a maximum value of the plurality of second automatic evaluation metric scores in response to the second human-generated labels indicating all of the outputs of the fourth machine learning model are not acceptable.
